(19) United States
(12) Patent Application Publication
(10) Pub. No.: US 2024/0418299 A1
(43) Pub. Date: Dec. 19, 2024

(54) MULTI-LAYERED PIPE

(71) Applicant: WAVIN B.V., Schipol (NL)

(72) Inventors: Henricus Josephus Geradus Anna GEURTS, Dedemsvaart (NL); Varun SRINIVAS, Schiphol (NL)

(73) Assignee: WAVIN B.V., Schipol (NL)

(21) Appl. No.: 18/714,961

(22) PCT Filed: Nov. 29, 2022
(86) PCT No.: PCT/EP2022/083720

§ 371 Date: May 30, 2024

(30) Foreign Application Priority Data
Nov. 30, 2021 (GB) 2117253.1

(51) Int. Cl. F16L 9/12

(52) U.S. Cl. CPC F16L 9/121; F16L 9/123

(57) ABSTRACT

A multi-layered pipe including a first polyethylene layer including raised temperature (PE-RT) resistance forming a longitudinal axis of the pipe, an ultra-high-molecular-weight polyethylene (UHMWPE) layer disposed around the first PE-RT layer, a second PE-RT layer disposed around the UHMWPE layer, and, optionally, at least one bonding layer disposed between at least one of the respective first or second PE-RT layers and the UHMWPE layer. At least one of the layers includes a nanoclay material for reducing gas transport through the layers.

### FIELD OF THE INVENTION

The present invention relates to a multi-layered pipe as well as to a method of manufacturing the same. In particular, the invention relates to a multi-layered pipe to be used for transportation of hot or cold fluids, for example in a heating, a cooling or a water supply system.

### BACKGROUND TO THE INVENTION

Multi-layered pipes have widely replaced single layer metal or plastic pipes, which were formerly commonly used in the building industry. By virtue of combining advantageous properties of the different layers such as e.g., special rigidity, resistance against corrosion and/or efficient manufacturability, they may outperform single layered pipes.

Multi-layered pipes including a barrier layer suited to block the passage of fluids such as air or moisture have been developed. Commonly used barrier layers comprise aluminium or EVOH (ethylene vinyl alcohol). Barrier layers can protect a fluid transported in the pipe against other fluids such as from contaminations in the ground diffusing into the pipe.

A pipe with high strength and temperature resistance as well as displaying the additional barrier properties would appear desirable. However, a problem encountered when attempting to manufacture a multi-layered pipe displaying both reinforcement as well as barrier properties, e.g., by combining the aforementioned pipe including a reinforcement layer with an additional barrier layer is that inter layer bonding and mechanical properties of the pipe deteriorate.

For example, it is known that vapour diffusion through the layers of a multi-layered pipe causes physical defects, which can lead to issues with pipe stability and longevity. Two types of physical defects which have been identified are blistering and bubbling. Blistering is caused by the emergence of small bubbles of air within one or more of the individual layers of a multi-layered pipe due to vapour diffusion from the liquid that the pipe is designed to transport. Bubbling is a similar, yet more serious, condition to that of blistering, as the air bubbles generated as a result of transporting the liquid through a multi-layered pipe are generally bigger than those produced during blistering. A further problem is that the larger bubbles tend to emerge at the interface between two of the layers in the multi-layered pipe, which can cause the layers to rupture or split apart. For example, a Technical Information Sheet 850624 dated January 2013 to Rehau acknowledges that “blistering may occur during operation on the pipe surface”. Both issues with vapour diffusion through the layers of a multi-layered pipe can give rise to defects in the pipe itself which lead to catastrophic failures, particularly when using pipes under pressure and/or temperature.

Nanoclays have previously been found to be useful in the food packaging industry. One of the emerging areas in this field is polymer nanocomposite (PNC) technology, which involves the incorporation of various chemicals and nanoadditives into polymers to improve their inherent properties or to add required functionality. Because the nanoparticles may interact with food components during processing, storage, or distribution and may migrate into food, PNC-based packaging materials require awareness and understanding of their potential impact on human health and the environment. Interest in migration and cytotoxic analysis of PNC has gained considerable momentum in recent years. It is known that clay-containing PNCs comprise 50% of all nanofillers, being nanoclays of either of natural or synthetic origin.

WO2021165290A1 discloses a multi-layer flexible packaging material comprising a paper layer, an aluminium layer, a nanoclay barrier coating layer, and a sealing layer applied to the surface of the nanoclay barrier coating layer representing the inner surface of the multi-layer flexible packaging material, said multilayer flexible barrier material being deprived of a polyolefin layer, such as a polyethylene (PE), polyethylene terephthalate (PET) or a polypropylene (PP) layer.

US2017029196A1 discloses heat sealable food packaging films, methods for the production thereof, and food packages comprising heat sealable food packaging films. The heat sealable food packaging film includes a humidity-dependent permeable film having a moisture vapor transmission rate that increases with an increase in relative humidity (RH). An outer coating comprises a coating material on at least one surface of the humidity-dependent permeable film. The coating material is selected from a nanoclay dispersed in a poly-vinylidene chloride (PVdC) polymer or a stretchable urethane polymer, a stretchable acrylic polymer, or a combination of stretchable urethane polymer and stretchable acrylic polymer.

DE10120620A1 discloses a multi-layered polyamide plastic pipe for conveying fluid media in heating and sanitary installations which comprises at least one layer which is constituted as a multi-material layer consisting of a polymer with embedded nanoclay processed as a filler element. The presence of several binder layers between the respective layers is required which leads to the increased risk of blistering occurring.

KR20110052265A discloses fuel injection pipe using a nano composite is provided to remarkably reduce the discharged amount of fuel evaporation gas generated when variable fuel is used. A fuel injection pipe using a nano composite comprises a nano composite. The nano composite is formed by mixing engineering plastic 97˜99.7% and nanoclay 0.3˜3% through extrusion or three-dimensional blow moulding. The engineering plastic is polyamide.

The use of nanoclays in combination with high-density or ultra-high molecular weight polyethylene has therefore not been considered for the transportation of hot or cold fluids in a heating, a cooling or a water supply system, to prevent the issues arising from blistering or bubbling in a multi-layered pipe. It would therefore be advantageous to overcome the problems of the prior art by incorporating a nanoclay material into one of the layers of a multi-layered pipe for reducing gas transport through the layers.

The use of

The invention is set out in accordance with the appended claims.

The present invention provides a multi-layered pipe comprising:
a) a first polyethylene layer comprising raised temperature (PE-RT) resistance forming a longitudinal axis of the pipe;
b) an ultra-high-molecular-weight polyethylene (UHMWPE) layer disposed around the first PE-RT layer;
c) a second PE-RT layer disposed around the UHMWPE layer; and
d) optionally, at least one bonding layer disposed between at least one of the respective first or second PE-RT layers and the UHMWPE layer;
characterised in that at least one of the layers comprises a nanoclay material for reducing gas transport through the layers.

Therefore, the present invention aims at providing a durable multi-layered pipe having good flexibility and strength, but which also provides an adequate oxygen barrier effect by employing a nanoclay material for reducing gas transport through the layers.

It has been surprisingly found that a multi-layered pipe having a layer comprising at least one nanoclay material provides for reducing gas transport through the layers of the pipe. The prevention of gases diffusing from the air surrounding the pipe into the liquid medium, especially at high operating temperatures or pressures of the fluid media carried within the pipe, is considered beneficial to prolonging the lifetime of the pipe.

Preferably the nanoclay is dispersed in at least one of the first or second PE-RT layers. Nanoclay materials are known to have excellent oxygen barrier properties to prevent vapour diffusion across the layers of the multi-layered pipe. More preferably the nanoclay is dispersed in the second (outer) PE-RT layer. A nanoclay-containing outer layer of the multi-layered pipe provides for an oxygen barrier layer immediately adjacent to the surrounding environment to maximise the reduction of potential water vapour diffusing across the layers of the multi-layered pipe which may otherwise cause blistering or bubbling.

Preferably the nanoclay is dispersed in the UHMWPE layer. Water uptake by the nanoclays is reduced with an increase in the concentration of the nanoclay when present in the UHMWPE layer. This improvement is attributed to the reduced water absorption of organoclay composites leading to less softening and plasticization of the UHMWPE polymer layer, resulting in better wear resistance.

Preferably the nanoclay is present in amount of at least 0.5 wt. % of the respective layer in which it is located, preferably 1.0 wt. %, preferably 1.5 wt. %, preferably 2.0 wt. %, preferably 2.5 wt. %, preferably 3.0 wt. %, preferably 3.5 wt. %, preferably 4.0 wt. %, preferably 4.5 wt. % or preferably 5.0 wt. %. Preferably the nanoclay is present in amount of up to 5 wt. % of the respective layer in which it is located, preferably 5.5 wt. %, preferably 6.0 wt. %, preferably 6.5 wt. %, preferably 7.0 wt. %, preferably 7.5 wt. %, preferably 8.0 wt. %, preferably 8.5 wt. %, preferably 9.0 wt. %, preferably 9.5 wt. %, preferably 10.0 wt. %, preferably 10.5 wt. %, preferably 11.0 wt. %, preferably 11.5 wt. %, preferably 12.0 wt. %. Preferably the nanoclay is present in an amount of up to 10 wt. % of the respective layer in which it is located. The permeability and diffusivity of water vapour through the various layers of a multi-layered pipe are considerably reduced by the incorporation of nanoclays into the polymer matrix at levels of up to 10 wt. % of the respective layer in which it is located.

Preferably the nanoclay is montmorillonite being a hydrated sodium calcium aluminium magnesium silicate hydroxide of the formula (Na,Ca)_{0.33}(Al,Mg)₂(Si₄O₁₀)(OH)₂·nH₂O). Nanoclay materials are known to have excellent oxygen barrier properties to prevent vapour diffusion. The incorporation of nanoclays into polymeric matrixes enhances the mechanical, physical, and barrier properties of polymers. Montmorillonite, kaolinite, and saponite are examples of nanoclays that have been used as fillers in the food systems. Montmorillonite in particular has attracted great interest in the food industry due to its cost effectiveness, availability, simple processability, and significant improvement in performance. Preferably, the nanoclay is Cloisite® Na⁺ which is an unmodified type of nanoclay material

Surface modification of nanoclays also provides for improved compatibility with polymer matrix to which it is embedded.

Preferably, the nanoclay is surface modified with a quaternary ammonium salt. Preferably, the quaternary ammonium salt is a modified dialkyldimethyl, arylalkyldimethyl or diaryldimethyl quaternary ammonium salt having the following general formula:

(CH₃)₂N⁺(R)₂
wherein each R group is, independently, a linear alkyl chain having from 8 to 18 carbon atoms, more preferably from 12 to 16 carbon atoms, or an aryl group having from 6 to 12 carbon atoms, more preferably 6 carbon atoms. Suitable counterions typically include chloride.

Preferably, the alkyl chains of the dialkyl or alkyl portion of the quaternary ammonium salt are of equal chain length. Preferably, such a carbon chain length comprises from 16 or 18 carbon atoms. This appears to improve thermal stability and provides better delamination of the clay when incorporated by mixing in polyethylene.

Preferably, the alkyl chains have hydroxyl end groups in order to improve compatibility with polar clay components, potentially providing shorter mixing times.

Preferably, the aryl group is benzyl. This appears to improve thermal stability such as required for processing of UHMWPE.

The clay/nanoclay may be a hydrophilic bentonite. The nanoclay may be any of Cloisite® 10 through 90 (including variants thereof such as with a prefix and postfix to the numerals) or chemical equivalent. Preferably, the nanoclay is selected from one or more of Cloisite® 10A, Cloisite® 15A, Cloisite® 20A, Cloisite® 30B or Cloisite® 93A. Most preferably, the nanoclay is Cloisite® 20A, as comprises cationic surfactant. Cloisite® 20A leads to a reduction in surface energy of the nanoclay material and helps in enhancing wettability in a polymer matrix. In addition, the presence of an aliphatic tail attached to the cationic group results in enhancement of d-spacing or interlayer spacing of the nanoclay layers, thereby improving exfoliation and associated physical properties.

Preferably, the amount of nanoclay present in the at least one of the layers of the multi-layered pipe is based upon the amount or number of cations that can be exchanged by another cation on the surface of the nanoclay mineral, the so-called cation exchange capacity (CEC) of the nanoclay material. It is often expressed in meq/100 g clay, which is numerically equivalent to cmol(+)/kg, where mol(+) represents moles of electrical charge. CEC is measured by displacing all the bound cations with a concentrated solution of another cation, and then measuring either the displaced cations or the amount of added cation that is retained. Barium (Ba²⁺) and ammonium (NH⁴⁺) may be used as exchanger cations.

Preferably, the amount of nanoclay present in the at least one of the layers of the multi-layered pipe is at least 80 meq/100 g of clay, preferably at least 85 meq/100 g of clay, preferably at least 90 meq/100 g of clay, preferably at least 95 meq/100 g of clay, preferably at least 100 meq/100 g of clay. Preferably the amount of nanoclay present in the at least one of the layers of the multi-layered pipe is at most 110 eq/100 g of clay, preferably at most 115 meq/100 g of clay, preferably at most 120 meq/100 g of clay, preferably at most 125 meq/100 g of clay, preferably at most 130 meq/100 g of clay, preferably at most 135 meq/100 g of clay, preferably at most 140 meq/100 g of clay. Preferably, the amount of nanoclay present in the at least one of the layers of the multi-layered pipe is at a concentration of between 90 to 125 meq/100 g of clay. By way of contrast, unmodified Cloisite® Na⁺ clay has a CEC value of 92.6 meq/100 g of clay.

The skilled person will appreciate that multi-layered pipes according to the present invention will vary in size according to the quantity of fluid they are designed to transport or the type of dwelling they are intended for use in, but will preferably have an outer pipe diameter in the range from 15 mm to 90 mm, more preferably in the range from 16 mm to 75 mm. The overall outer wall thickness comprising the various layers of the multi-layered pipes is therefore preferably in the range from 1.5 mm to 9 mm, more preferably 2 mm to 7.5 mm.

Preferably, the thickness of the first PE-RT layer is at least 0.5 mm, preferably at least 0.6 mm, preferably at least 0.7 mm, preferably at least 0.8 mm, preferably at least 0.9 mm, preferably at least 1.0 mm, preferably at least 1.1 mm, preferably at least 1.2 mm, preferably at least 1.3 mm, preferably at least 1.4 mm, preferably at least 1.5 mm, preferably at least 1.6 mm, preferably at least 1.7 mm, preferably at least 1.8 mm, preferably at least 1.9 mm, preferably at least 2.0 mm, preferably at least 2.1 mm, preferably at least 2.2 mm, preferably at least 2.3 mm, preferably at least 2.4 mm or preferably at least 2.5 mm. Preferably the thickness of the first PE-RT layer is at most 6.5 mm, preferably at most 6.6 mm, preferably at most 6.7 mm, preferably at most 6.8 mm, preferably at most 6.9 mm, preferably at most 7.0 mm, preferably at most 7.1 mm, preferably at most 7.2 mm, preferably at most 7.3 mm, preferably at most 7.4 mm, preferably at most 7.5 mm, preferably at most 7.6 mm, preferably at most 7.7 mm, preferably at most 7.8 mm, preferably at most 7.9 mm, preferably at most 8.0 mm, preferably at most 8.1 mm, preferably at most 8.2 mm, preferably at most 8.3 mm, preferably at most 8.4 mm or preferably at most 8.5 mm. Preferably the thickness of the first PE-RT layer is in the range 1.3 mm to 7.2 mm. This is good because the first PE-RT layer, the inner layer of pipe, is made as thick as possible in order to allow for the outer layer (the second PE-RT layer) of the multi-layered pipe to be as thin as possible. Also, it is preferred that a thinner outer layer helps with compatibility with certain exterior fittings.

Preferably, the thickness of the second PE-RT layer is at least 0.1 mm, preferably at least 0.2 mm, preferably at least 0.3 mm, preferably at least 0.4 mm, preferably at least 0.5 mm, preferably at least 0.6 mm, preferably at least 0.7 mm or preferably at least 0.8 mm. Preferably the thickness of the second PE-RT layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the second PE-RT layer is in the range 0.1 mm to 0.9 mm. The thickness of the second PE-RT layer is selected to be as thin as possible so that in scenarios where the nanoclay layer is present in this layer, it is easier for the second PE-RT layer (outer) to be compatible with certain exterior fittings.

Preferably, the thickness of the UHMWPE layer is at least 0.1 mm, preferably at least 0.2 mm, preferably at least 0.3 mm, preferably at least 0.4 mm or preferably at least 0.5 mm. Preferably the thickness of the UHMWPE layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the UHMWPE layer is in the range 0.1 mm to 0.7 mm.

Preferably the UHMWPE layer comprises a UHMWPE tape or a fibre. A UHMWPE layer comprising a UHMWPE tape or a fibre provides for a thicker reinforcing layer of the multi-layered pipe.

Preferably the UHMWPE tape layer comprises two layers of tape with one layer on top of the other. In this manner, the UHMWPE layer is formed from several layers of UHMWPE tape which increases the strength of the UHMWPE tape while maintaining the overall flexibility of the UHMWPE tape layer itself, as well as that of the multi-layered pipe.

Preferably the two layers of tape have an angle of overlap between them of at least 20° degrees, preferably at least 25° degrees, preferably at least 30° degrees, preferably at least 35° degrees, preferably at least 40° degrees, preferably at least 45° degrees, preferably at least 50° degrees or preferably at least 55° degrees. Preferably the two layers of tape have an angle of overlap between them of at most 60° degrees, preferably at most 65° degrees, preferably at most 70° degrees, preferably at most 75° degrees, preferably at most 80° degrees, preferably at most 85° degrees or preferably at most 90° degrees. Preferably the two layers of tape have an angle of overlap between them of from 40° to 70° degrees. It has been found that when the two layers of tape have an angle of overlap between them in this range then this maximises the strength and flexibility of the UHMWPE tape layer.

Preferably the multi-layered pipe further comprise a bonding layer disposed between the first PE-RT layer and the UHMWPE layer, and/or a bonding layer disposed between the second PE-RT layer and the UHMWPE layer. While not an essential requirement to the present invention, additional bonding layers, whether present between the first PE-RT layer and the UHMWPE layer, and/or between the second PE-RT layer and the UHMWPE layer allow the corresponding first or second PE-RT layer(s) and the UHMWPE layer to more strongly adhere to each other to minimise seam openings between the layers which may be exploited by blistering or bubbling phenomena.

Preferably the nanoclay is dispersed in the bonding layer disposed between the first PE-RT layer and the UHMWPE layer, and/or the nanoclay is dispersed in the bonding layer disposed between the second PE-RT layer and the UHMWPE layer. In this manner, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling.

Preferably the at least one bonding layer is formed from high density polyethylene (HDPE), HDPE grafted with maleic anhydride (HDPE-g-MA), low density polyethylene (LDPE), LDPE grafted with maleic anhydride (LDPE-g-MA) or combinations thereof. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Preferably, the thickness of the at least one bonding layer is at least 0.1 mm, preferably at least 0.2 mm, preferably at least 0.3 mm, preferably at least 0.4 mm, preferably at least 0.5 mm, preferably at least 0.6 mm, preferably at least 0.7 mm or preferably at least 0.8 mm. Preferably the thickness of the second PE-RT layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the at least one bonding layer is in the range 0.1 to 0.9 mm. More preferably the thickness of the at least one bonding layer is in the range 0.2 mm to 0.6 mm. The thickness of the at least one bonding layer is selected so as to not be too thick, otherwise it affects the long-term performance of the multi-layered pipe. For example, when the at least one bonding layer is an LDPE-based bonding layer it has a lower melting point compared with layers comprised of PE-RT or UHMWPE. In general, the thickness of the at least one bonding layer is at most 10% of the overall pipe diameter.

Preferably the at least one bonding layer is free from ethylene vinyl alcohol (EVOH). EVOH is known to be a strong barrier against oxygen and gas, it is difficult to make and therefore more expensive. The use of EVOH also provides disadvantages in terms of recyclability, and the fact that when it is used additional tie layers are required in order to bond various layers of the pipe together.

Preferably the multi-layered pipe is free from aluminium. A polymeric multi-layered pipe that does not comprise aluminium maintains good flexibility and can therefore be used in a variety of scenarios where flexibility is useful, e.g., to transport liquids around corners.

Preferably the multi-layered pipe has a density of less than 1 g/cm³. This is good because it is cheaper and easier to transport than conventional metal or concrete alternatives.

Accordingly, the invention provides for a multi-layered pipe for conveying hot water in a dwelling, the pipe consisting of concentric layers of polymeric material, the layers being:
an inner first PE-RT layer;
a UHMWPE layer; and
an outer second PE-RT layer comprising a nanoclay material.

A multi-layered pipe comprising a nanoclay-containing outer layer of the multi-layered pipe provides for an oxygen barrier layer immediately adjacent to the surrounding environment to maximise the reduction of potential water vapour diffusing across the layers of the multi-layered pipe which may otherwise cause blistering or bubbling.

Alternatively, the invention provides for a multi-layered pipe for conveying hot water in a dwelling, the pipe consisting of concentric layers of polymeric material, the layers being:
an inner first PE-RT layer;
a UHMWPE layer comprising a nanoclay material; and
an outer second PE-RT layer.

This is good because water uptake by the nanoclays is reduced with an increase in the concentration of the nanoclay when present in the UHMWPE layer. This improvement is attributed to the reduced water absorption of organoclay composites leading to less softening of the UHMWPE polymer layer, resulting in better wear resistance.

Alternatively, the invention provides for a multi-layered pipe for conveying hot water in a dwelling, the pipe consisting of concentric layers of polymeric material, the layers being:
an inner first PE-RT layer;
a first LDPE bonding layer comprising a nanoclay material;
a UHMWPE layer;
a second LDPE bonding layer comprising a nanoclay material; and
an outer second PE-RT layer.

In this embodiment, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Alternatively, the invention provides for a multi-layered pipe for conveying hot water in a dwelling, the pipe consisting of concentric layers of polymeric material, the layers being:
an inner first PE-RT layer;
a LDPE bonding layer;
a UHMWPE layer; and
an outer second PE-RT layer comprising a nanoclay material.

This is good because water uptake by the nanoclays is reduced with an increase in the concentration of the nanoclay when present in the UHMWPE layer. This improvement is attributed to the reduced water absorption of organoclay composites leading to less softening and plasticization of the UHMWPE polymer layer, resulting in better wear resistance. In addition, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Preferably, a portion of the UHMWPE layer may be dispersed in at least one of the first or second PE-RT layers. In scenarios when the UHMWPE layer comprises a UHMWPE tape or a fibre, preferably the UHMWPE tapes or fibres are dispersed in at least one of the first or second PE-RT layers to form a matrix. The skilled person will appreciate that in scenarios when a portion of the UHMWPE layer may be dispersed in at least one of the first or second PE-RT layers, the nanoclay may still be dispersed in at least one of the first or second PE-RT layers or dispersed in the UHMWPE layer in accordance with a first embodiment of the invention. In this manner, at least one of the first or second PE-RT layers of the multi-layered pipe may therefore further comprise a mixture of UHMWPE tapes or fibres and at least one nanoclay material.

Accordingly, a second embodiment of the invention relates to a method of manufacturing a multi-layered polymer pipe according to any preceding claim, the method comprising the steps of:
melt-extruding a first PE-RT layer to form a longitudinal axis of the pipe;
melt-extruding a UHMWPE layer over the first PE-RT layer; and
applying a second PE-RT layer over the UHMWPE layer.

Such a method is considered to be cheaper and easier to carry out in order to manufacture a multi-layered pipe according to a first embodiment of the present invention because i) fewer layers are required to form the multi-layered pipe, ii) those that are required can easily bond and adhere together due to the similar chemical nature of the individual layers, and iii) the entire process can be carried out using existing technology.

Preferably the method of manufacturing a multi-layered polymer pipe comprises the additional steps of:
applying a bonding layer over the first PE-RT layer prior to melt-extruding the UHMWPE layer; and/or
applying a bonding layer over the UHMWPE layer prior to applying the second PE-RT layer.

The incorporation of one or more additional bonding layers improves the bonding between the existing layers of the multi-layered pipe, to increase the overall strength and flexibility of the multi-layered pipe while simultaneously maximising the reduction of potential water vapour diffusing across the layers of the multi-layered pipe.

The PE-RT polymer is resilient and allows considerable elastic deformation. In some uses it is desirable that the multi-layered polymer pipe of the present invention is deformable, such as in bending, a typical requirement in applications, but it does not show significant resilient recovery upon bending. The resilience of the multi-layered pipe of the present invention is therefore preferably reduced. Reduction of resilience may be conveniently achieved by the use of fillers, which can be termed bulk fillers. However, the use of nanoclay (a functional filler) and its beneficial effects, as described above, can be adversely affected by the introduction of other fillers, by a filler is meant a physical particulate in addition to the polymer. It is therefore preferable to limit the resilience (elastic recovery) of the multi-layered pipe of the present invention without providing additional solids materials to the UHMWPE layer. It has been found that the desired characteristics can be achieved by adding a filler to the PE-RT composition. However, it has been found that not all fillers are suitable and certainly not as equally effective in combination with nanoclay.

A filler, that is a material of larger particle size than a nanoclay filler, for example being of particle size 1 μm or great, preferably less than 100 μm. more preferably in the range 2μ to 50 μm. Such a filler may be referred to as a bulk filler to differentiate it from the nanoclay which, whilst different in particle size can be considered as acting technically as a filler, all be it a functional filler having desirable effects. The person skilled in the art does not normally consider the (expensive) functional components such as a nanoclay as a filler/bulk filler as that is not its function.

Filler suitable for inclusion in the PE-RT layer(s) of the present invention includes: Talc—Mg3Si4O10(OH)2; Calcium Carbonate—CaCO3; Kaolinite—Al2Si2O5(OH)4; Wollastonite—CaSiO3; Mica muscovite—KA12(Si3AlO10)(OH)2; Mica phlogopite—KMg3(AlSi3O10)(OH)2; Glass beads or fibre—SiO2. The preferred filler is Talc as this provides the greatest reduction in resilient recovery of a bent pipe in a pipe comprising a PE/RT layer utilising this filler.

In the present invention a filler may be included at a level of between 5 and 60% by weight in the first (inner) PE-RT layer. A preferred level for reduction in resilient recovery of a bent pipe is between 10 and 50% by weight.

Alternatively, a filler may be included at a level of between 10 and 60% by weight in a second PE-RT layer disposed around the UHMWPE layer.

The filler may be used in both of the PE-RT layers.

However, a filler incorporated into the PE-RT as an inner layer can potentially come into contact with water in the pipes and the fourth for potable water it can be preferable to have the filler in the second PE-RT layer even if this is less effective.

In terms of the desirable characteristic of a pipe of the invention retaining its deformation after bending (longitudinal bending) it has been found that incorporating the filler in the first (inner) PE-RT layer is the more effective. Incorporating the filler in the second (outer) is also effective in reducing resilient recovery after pipe bending, but less so.

When the nanoclay incorporated in the PE-RT layer it is preferably incorporated in the inner later for reducing gas transport, as moisture, from the contents of the pipe. The presence of filler (i.e., bulk filler with the nano clay is disadvantageous as it increases the gas permeability, the bulk filler is therefore preferably in another PE-RT layer. The bulk filler is therefore preferably place in the outer PE-RT layer.

The layer comprising the nanoclay preferably comprises no other solids component polymeric additive besides the nanoclay. The layer comprising the nano clay preferably consists of polymer and nano clay, optionally we trace additives are less than 5% in total by weight. The layer comprising the filler preferably consists of the filler and polymer, optionally with trace relatives at less than 5% in total by weight.

### BRIEF DESCRIPTION OF THE DRAWINGS

The description is given with reference to the accompanying drawings where like numerals are intended to refer to like parts and in which:

FIG. 1 represents a cross-sectional view of a multi-layered pipe according to a first embodiment of the invention;

FIG. 2 represents a cross-sectional view of a multi-layered pipe according to an alternative first embodiment of the invention;

FIG. 3 represents a cross-sectional view of a multi-layered pipe according to an alternative first embodiment of the invention; and

FIG. 4 represents a cross-sectional view of a multi-layered pipe according to an alternative first embodiment of the invention.

The following abbreviations have been used extensively throughout the description.

### ABBREVIATIONS

PE-RT: polyethylene of raised temperature resistance;
HDPE: high-density polyethylene;
LDPE: low-density polyethylene;
UHMWPE: ultra-high-molecular-weight polyethylene;
(HD/LD) PE-g-MA: (high-density/low-density) polyethylene-graft-maleic anhydride.

For the avoidance of any doubt, a corresponding definition of each of the acronyms used is provided below.

### Definitions

PE-RT is a polyethylene (PE) resin in which the molecular architecture has been designed such that a sufficient number of tie chains are incorporated to allow operation at elevated or raised temperatures (RT). Tie chains “tie” together the crystalline structures in the polymer, resulting in improved properties such as elevated temperature strength and performance, chemical resistance and resistance to slow crack growth.

HDPE or polyethylene high-density (PEHD) is a thermoplastic polymer produced from the monomer ethylene. HDPE is known for its high strength-to-density ratio. HDPE pipe does not rust, rot or corrode, and is resistant to biological growth. This means an extended service life and long-term cost savings. The density of HDPE ranges from 0.93 to 0.97 g/cm³. Although the density of HDPE is only marginally higher than that of low-density polyethylene, HDPE has little branching, giving it stronger intermolecular forces and tensile strength (38 MPa versus 21 MPa) than LDPE. The difference in strength exceeds the difference in density, giving HDPE a higher specific strength. It is also harder, more opaque and can withstand somewhat higher temperatures (120° C./248° F. for short periods). High-density polyethylene, unlike polypropylene, cannot withstand normally required autoclaving conditions. The lack of branching is ensured by an appropriate choice of catalyst (e.g., Ziegler-Natta catalysts) and reaction conditions. HDPE is resistant to many different solvents, so it cannot be glued, pipe joints must be made by welding, but this makes pipes constructed out of HDPE ideally suited for transporting drinking water and waste water (storm and sewage).

LDPE is a thermoplastic also made from the monomer ethylene. LDPE is defined by a density range of 0.917 to 0.93 g/cm³. At room temperature it is not reactive, except to strong oxidizers; some solvents cause it to swell. It can withstand temperatures of 65° C. (149° F.) continuously and 90° C. (194° F.) for a short time. Made in translucent and opaque variations, it is quite flexible and tough. LDPE has more branching (on about 2% of the carbon atoms) than HDPE, so its intermolecular forces (instantaneous-dipole induced-dipole attraction) are weaker, its tensile strength is lower, and its resilience is higher. The side branches mean that its molecules are less tightly packed and less crystalline, and therefore its density is lower. When exposed to consistent sunlight, the plastic produces significant amounts of two greenhouse gases: methane and ethylene. Because of its lower density (high branching), it breaks down more easily than other plastics; as this happens, the surface area increases. Production of these trace gases from virgin plastics increases with surface area and with time, so that LDPE emits greenhouse gases at a more unsustainable rate than other plastics. When incubated in air, LDPE emits methane and ethylene at rates about 2 times and about 76 times, respectively, more than in water.

A UHMWPE is a polyethylene polymer that comprises primarily ethylene-derived units and in some embodiments, the UHMWPE is a homopolymer of ethylene. Optionally, a UHMWPE may comprise additional α-olefins such as, but not limited to, 1-butene, 1-pentene, 1-hexene, 1-octene, 1-decene, 1-dodecene, 4-methyl-1-pentene, and 3-methyl-1-pentene. A suitable UHMWPE may have a weight average molecular weight (Mw) of about 1,500,000 g/mol or greater, about 1,750,000 g/mol or greater, about 1,850,000 g/mol or greater, or about 1,900,000 g/mol or greater. These molecules are several orders of magnitude longer than those of familiar HDPE due to a synthesis process based on metallocene catalysts, resulting in UHMWPE molecules typically having 100,000 to 250,000 monomer units per molecule each compared to HDPE's 700 to 1,800 monomers. Examples of commercially available UHMWPE include MIPLEON™ XM-220, MIPLEON™ XM-330 (both available from Mitsui Chemical), Ticona GUR™ 4170 (available from Celanese, Dallas, TX, USA), UTEC3040 (Braskem), LUBMER™ 5000 and LUBMER™ 5220 (both available from Mitsui Chemical).

Suitable UHMWPE may be in a powder or pellet form and/or have an average particle diameter of about 75 μm or less, about 70 μm or less, or about 65 μm or less. Additionally, or alternatively, suitable UHMWPE may have an average particle diameter of 10 μm or greater, 15 μm or greater, 20 μm or greater, or 25 μm greater. Additionally, or alternatively, suitable UHMWPE may have an average particle diameter of about 40 μm to about 75 μm, such as about 50 μm to about 70 μm, or about 55 μm to 65 μm. Additionally, or alternatively, suitable UHMWPE may have an average particle diameter of about 10 μm to about 50 μm, such as about 15 μm to about 45 μm, about 20 μm to about 40 μm, or about 25 μm to about 30 μm.

Particle size in the present invention is determined by ASTM E2834-12 (2022) suitable equipment is the NanoSight NS300 from Malvern Panalytical®. This is suitable for the nano clay. For larger particles than the nano scale, such as the bulk filler, particle size may be determined using a Mastersizer 3000 Malvern Panalytical®.

Water may be used as the medium for suspending the solid in analysis. Measurement are made at 25° C. unless the method requires otherwise. The preferred particle size measurement is D3,2 unless the method requires otherwise. Plastics particle size may be measured using ASTM D7486-14.

PE-g-MA, structure reproduced below for reference, is a compatibilizer for polymer blends which serves as support for polar to nonpolar substances:

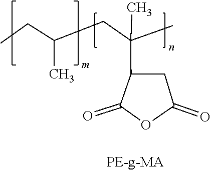

It is known that PE-g-MA introduced or admixed with LDPE/HDPE results in blends which have higher thermal stability. This is a desirable property for the formation of multi-layered pipes.

### DETAILED DESCRIPTION OF THE INVENTION

### Example 1

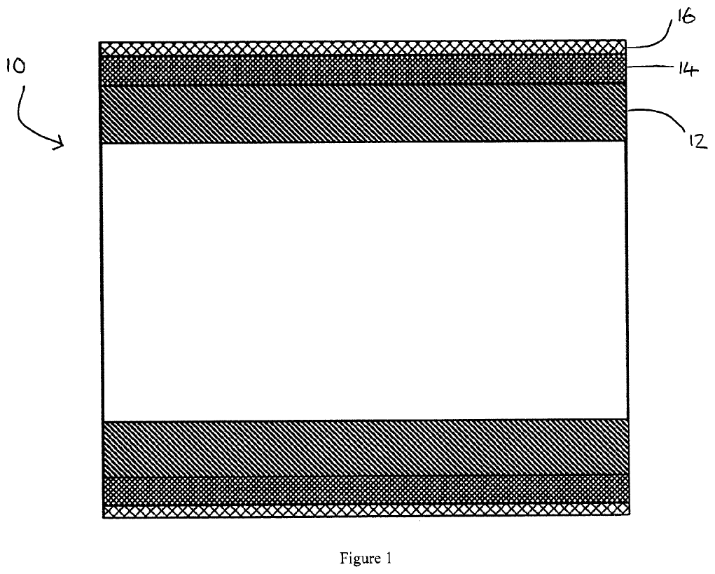

FIG. 1 shows a view of a multi-layered pipe (10) in cross-section according to a first embodiment of the invention. More specifically, FIG. 1 shows a multi-layered pipe (10) having concentric layers of polymeric material being arranged sequentially on top of each other and consisting of a first PE-RT layer (12) forming a longitudinal axis of the pipe (10), a UHMWPE layer (14) containing dispersed UHMWPE tapes/fibres disposed around the first PE-RT layer (12), and a second PE-RT layer (16) comprising a nanoclay material disposed around the UHMWPE layer (14). The nanoclay material in the second PE-RT layer (16) is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

The multi-layered pipe (10) was produced by melt-extruding the first PE-RT layer (12) forming a longitudinal axis of the pipe (10), melt-extruding the UHMWPE layer (14) around the first PE-RT layer (12) and applying the second (outer) PE-RT layer (16) containing the nanoclay around the UHMWPE layer (14).

### Example 2

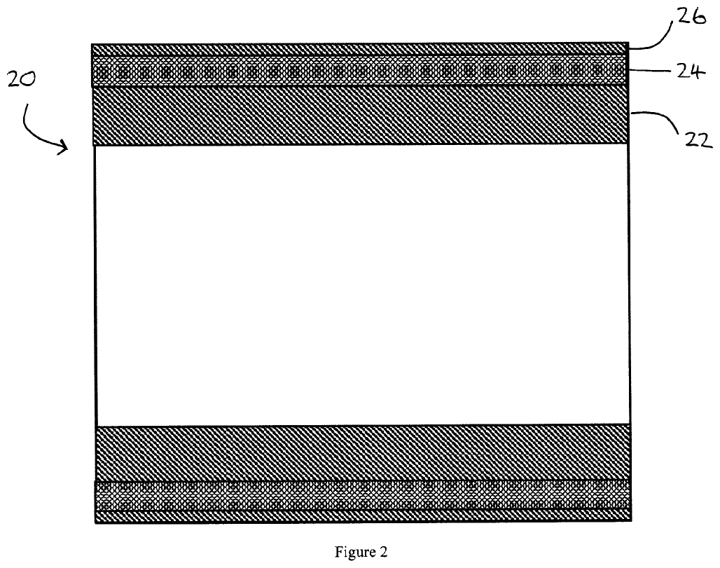

FIG. 2 shows a view of a multi-layered pipe (20) in cross-section according to an alternative first embodiment of the invention. More specifically, FIG. 2 shows a multi-layered pipe (20) having concentric layers of polymeric material being arranged sequentially on top of each other and consisting of a first PE-RT layer (22) forming a longitudinal axis of the pipe (20), a UHMWPE layer (24) comprising a nanoclay material disposed around the first PE-RT layer (22), and a second PE-RT layer (26) disposed around the UHMWPE layer (24). The nanoclay material in the UHMWPE layer (24) is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

The multi-layered pipe (20) was produced by melt-extruding the first PE-RT layer (22) forming a longitudinal axis of the pipe (20), melt-extruding the UHMWPE layer (24) containing the nanoclay around the first PE-RT layer (22) and applying the second (outer) PE-RT layer (26) around the UHMWPE layer (24).

### Example 3

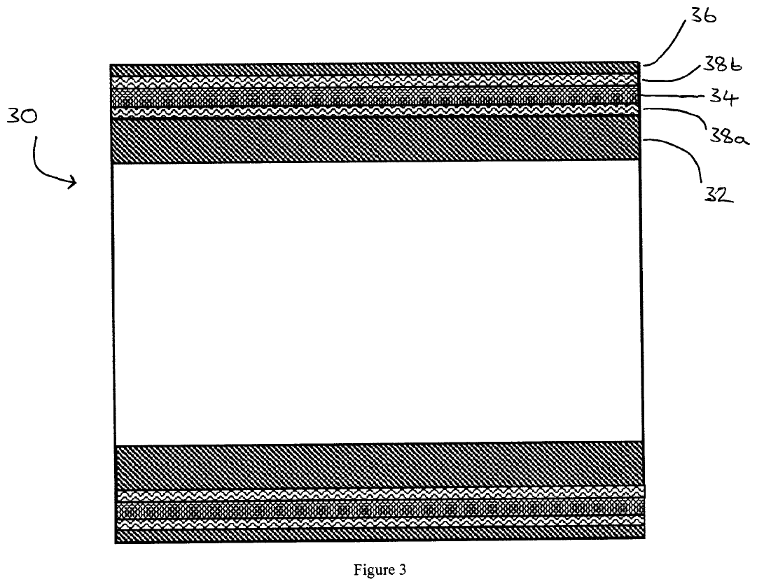

FIG. 3 shows a view of a multi-layered pipe (30) in cross-section according to an alternative first embodiment of the invention. More specifically, FIG. 3 shows a multi-layered pipe (30) having concentric layers of polymeric material being arranged sequentially on top of each other and consisting of a first PE-RT layer (32) forming a longitudinal axis of the pipe (30), a first LDPE bonding layer (38a) comprising a nanoclay material disposed around the first PE-RT layer (32), a UHMWPE tape layer (34) disposed around the first LDPE bonding layer (38a), a second LDPE bonding layer (38b) comprising a nanoclay material disposed around the UHMWPE tape layer (34) and a second PE-RT layer (36) disposed around the second LDPE bonding layer (38b). The nanoclay material in each of the first (38a) and second (38b) LDPE bonding layers is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

The multi-layered pipe (30) was produced by melt-extruding the first PE-RT layer (32) forming a longitudinal axis of the pipe (30), applying the first LDPE bonding layer (38a) containing the nanoclay around the first PE-RT layer (32), applying the UHMWPE tape layer (34) by winding layers of UHMWPE tape around the first LDPE bonding layer (38a), applying the second LDPE bonding layer (38b) containing the nanoclay around the UHMWPE tape layer (34) and applying the second (outer) PE-RT layer (36) around the second LDPE bonding layer (38b).

### Example 4

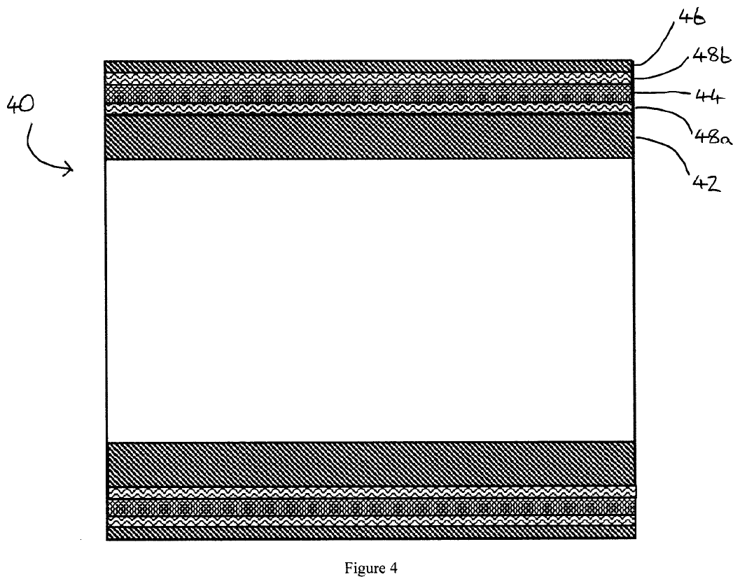

FIG. 4 shows a view of a multi-layered pipe (40) in cross-section according to an alternative first embodiment of the invention. More specifically, FIG. 4 shows a multi-layered pipe (40) having concentric layers of polymeric material being arranged sequentially on top of each other and consisting of a first PE-RT layer (42) forming a longitudinal axis of the pipe (40), a first LDPE bonding layer (48a) disposed around the first PE-RT layer (42), a UHMWPE tape layer (44) disposed around the first LDPE bonding layer (48a), a second LDPE bonding layer (48b) disposed around the UHMWPE layer (44) and a second PE-RT layer (46) comprising a nanoclay material disposed around the second LDPE bonding layer (48b). The nanoclay material is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

The multi-layered pipe (40) was produced by melt-extruding the first PE-RT layer (42) forming a longitudinal axis of the pipe (40), applying the first LDPE bonding layer (48a) around the first PE-RT layer (42), applying the UHMWPE layer (44) by winding layers of UHMWPE tape around the first LDPE bonding layer (48a), applying the second LDPE bonding layer (48b) around the UHMWPE tape layer (44) and applying the second (outer) PE-RT layer (46) containing the nanoclay around the second LDPE bonding layer (48b).

The following numbered sentences describe the present invention:
1 A multi-layered pipe comprising:
   a) a first polyethylene layer comprising raised temperature (PE-RT) resistance forming a longitudinal axis of the pipe;
   b) an ultra-high-molecular-weight polyethylene (UHMWPE) layer disposed around the first PE-RT layer;
   c) a second PE-RT layer disposed around the UHMWPE layer; and
   d) optionally, at least one bonding layer disposed between at least one of the respective first or second PE-RT layers and the UHMWPE layer;
   characterised in that at least one of the layers comprises a nanoclay material for reducing gas transport through the layers.
2. The multi-layered pipe according to claim 1, wherein the nanoclay is dispersed in at least one of the first or second PE-RT layers.
3. The multi-layered pipe according to claim 1, wherein the nanoclay is dispersed in the UHMWPE layer.
4. The multi-layered pipe according to any of claim 1 to claim 3, wherein the nanoclay is present in an amount of up to 10 wt. % of the respective layer in which it is located.
5. The multi-layered pipe according to any preceding claim, wherein the nanoclay is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O).
6. The multi-layered pipe according to claim 5, wherein the nanoclay is modified with a dialkyldimethyl, arylalkyldimethyl or diaryldimethyl quaternary ammonium salt having the following general formula:

(CH₃)₂N⁺(R)₂
wherein each R group is, independently, a linear alkyl chain having from 8 to 18 carbon atoms, or an aryl group having from 6 to 12 carbon atoms.
7. The multi-layered pipe according to any preceding claim, wherein the thickness of the first PE-RT layer is in the range 1.3 to 7.2 mm.
8. The multi-layered pipe according to any preceding claim, wherein the thickness of the second PE-RT layer is in the range 0.1 to 0.9 mm.
9. The multi-layered pipe according to any preceding claim, wherein the thickness of the UHMWPE layer is in the range 0.1 to 0.7 mm.
10. The multi-layered pipe according to any preceding claim, wherein the UHMWPE layer comprises a UHMWPE tape or a fibre.
11. The multi-layered pipe according to claim 10, wherein the UHMWPE tape layer comprises two layers of tape with one layer on top of the other.
12. The multi-layered pipe according to claim 11, wherein the two layers of tape have an angle of overlap between them of from 40° to 70° degrees.
13. The multi-layered pipe according to any preceding claim, further comprising a bonding layer disposed between the first PE-RT layer and the UHMWPE layer, and/or a bonding layer disposed between the second PE-RT layer and the UHMWPE layer.
14. The multi-layered pipe according to claim 13, wherein the nanoclay is dispersed in the bonding layer disposed between the first PE-RT layer and the UHMWPE layer, and/or the nanoclay is dispersed in the bonding layer disposed between the second PE-RT layer and the UHMWPE layer.
15. The multi-layered pipe according to any preceding claim, wherein the at least one bonding layer is formed from high density polyethylene (HDPE), HDPE grafted with maleic anhydride (HDPE-g-MA), low density polyethylene (LDPE), LDPE grafted with maleic anhydride (LDPE-g-MA) or combinations thereof.
16. The multi-layered pipe according to any preceding claim, wherein the thickness of the at least one bonding layer is in the range 0.1 to 0.9 mm.
17. The multi-layered pipe according to any preceding claim, wherein the at least one bonding layer is free from ethylene vinyl alcohol (EVOH).
18. The multi-layered pipe according to any preceding claim, wherein the pipe is free from aluminium.
19. The multi-layered pipe according to any preceding claim, having a density of less than 1 g/cm³.
20. A multi-layered pipe for conveying hot water in a dwelling, the pipe consisting of concentric layers of polymeric material, the layers being:
   an inner first PE-RT layer;
   a UHMWPE layer; and
   an outer second PE-RT layer comprising a nanoclay material.
21. A multi-layered pipe for conveying hot water in a dwelling, the pipe consisting of concentric layers of polymeric material, the layers being:
   an inner first PE-RT layer;
   a UHMWPE layer comprising a nanoclay material; and
   an outer second PE-RT layer.
22. A multi-layered pipe for conveying hot water in a dwelling, the pipe consisting of concentric layers of polymeric material, the layers being:
   an inner first PE-RT layer;
   a first LDPE bonding layer comprising a nanoclay material;
   a UHMWPE layer;
   a second LDPE bonding layer comprising a nanoclay material; and
   an outer second PE-RT layer.
23. A multi-layered pipe for conveying hot water in a dwelling, the pipe consisting of concentric layers of polymeric material, the layers being:
   an inner first PE-RT layer;
   a LDPE bonding layer;
   a UHMWPE layer; and
   an outer second PE-RT layer comprising a nanoclay material.
24. A method of manufacturing a multi-layered polymer pipe according to any preceding claim, the method comprising the steps of:
   melt-extruding a first PE-RT layer to form a longitudinal axis of the pipe;
   melt-extruding a UHMWPE layer over the first PE-RT layer; and
   applying a second PE-RT layer over the UHMWPE layer.
25. The method according to claim 25, further comprising the additional steps of:
   applying a bonding layer over the first PE-RT layer prior to melt-extruding the UHMWPE layer; and/or
   applying a bonding layer over the UHMWPE layer prior to applying the second PE-RT layer.

1. A multi-layered pipe comprising:
a) a first polyethylene layer comprising raised temperature (PE-RT) resistance forming a longitudinal axis of the pipe;
b) an ultra-high-molecular-weight polyethylene (UHMWPE) layer disposed around the first PE-RT layer;
c) a second PE-RT layer disposed around the UHMWPE layer; and
d) optionally, at least one bonding layer disposed between at least one of the respective first or second PE-RT layers and the UHMWPE layer;
characterised in that at least one of the layers comprises a nanoclay material for reducing gas transport through the layers.

2. The multi-layered pipe according to claim 1, wherein the nanoclay is dispersed in at least one of the first or second PE-RT layers.

3. The multi-layered pipe according to claim 1, wherein the nanoclay is dispersed in the UHMWPE layer.

4. The multi-layered pipe according to claim 1, wherein the nanoclay is present in an amount of up to 10 wt. % of the respective layer in which it is located.

5. The multi-layered pipe according to claim 1, wherein the nanoclay is a surface modified montmorillonite being a hydrated sodium calcium aluminium magnesium silicate hydroxide of the formula (Na,Ca)_{0.33}(A1,Mg)₂(Si₄O₁₀)(OH)₂ₙH₂O).

6. The multi-layered pipe according to claim 5, wherein the nanoclay is modified with a dialkyldimethyl, arylalkyldimethyl or diaryldimethyl quaternary ammonium salt having the following general formula:
(CH₃)₂N⁺(R)₂
wherein each R group is, independently, a linear alkyl chain having from 8 to 18 carbon atoms, or an aryl group having from 6 to 12 carbon atoms.

7. The multi-layered pipe according to claim 1, wherein the UHMWPE layer comprises a UHMWPE tape or a fibre.

8. The multi-layered pipe according to claim 1, further comprising a bonding layer disposed between the first PE-RT layer and the UHMWPE layer, and/or a bonding layer disposed between the second PE-RT layer and the UHMWPE layer.

9. The multi-layered pipe according to claim 8, wherein the nanoclay is dispersed in the bonding layer disposed between the first PE-RT layer and the UHMWPE layer, and/or the nanoclay is dispersed in the bonding layer disposed between the second PE-RT layer and the UHMWPE layer.

10. The multi-layered pipe according to claim 1, wherein the at least one bonding layer is formed from high density polyethylene (HDPE), HDPE grafted with maleic anhydride (HDPE-g-MA), low density polyethylene (LDPE), LDPE grafted with maleic anhydride (LDPE-g-MA) or combinations thereof.

11. The multi-layered pipe according to claim 1, wherein the thickness of the at least one bonding layer is in the range 0.1 to 0.9 mm.

12. The multi-layered pipe according to claim 1, wherein the at least one bonding layer is free from ethylene vinyl alcohol (EVOH).

13. The multi-layered pipe according to claim 1, wherein the pipe is free from aluminium.

14. A method of manufacturing a multi-layered polymer pipe according to claim 1, the method comprising the steps of
melt-extruding a first PE-RT layer to form a longitudinal axis of the pipe;
melt-extruding a UHMWPE layer over the first PE-RT layer; and
applying a second PE-RT layer over the UHMWPE layer.

15. The method according to claim 14, further comprising the additional steps of: applying a bonding layer over the first PE-RT layer prior to melt-extruding the UHMWPE layer; and/or
applying a bonding layer over the UHMWPE layer prior to applying the second PERT layer.
